(19) United States
(12) Patent Application Publication
(10) Pub. No.: US 2025/0278269 A1
(43) Pub. Date: Sep. 4, 2025

(54) INFORMATION PROCESSING DEVICE, INFORMATION PROCESSING METHOD, AND COMPUTER PROGRAM

(71) Applicant: SONY GROUP CORPORATION, TOKYO (JP)

(72) Inventors: RYOTA YUKAWA, TOKYO (JP); SHOTA MATSUZAKI, TOKYO (JP)

(21) Appl. No.: 18/858,075

(22) PCT Filed: Mar. 2, 2023
(86) PCT No.: PCT/JP2023/007883

§ 371 Date: Oct. 18, 2024

(30) Foreign Application Priority Data
Apr. 27, 2022 (JP) 2022-073804

(51) Int. Cl. G06F 8/73; G06F 11/3668

(52) U.S. Cl. CPC G06F 8/73; G06F 11/3684

(57) ABSTRACT

An information processing device that automatically generates a test code is provided.

The information processing device generates a constraint from at least one of a source code, an annotation written in a source code or an annotation of a source code written in an external file, generates a source code that runs on a symbol execution engine and is obtained by symbolizing a motion and an input on the basis of the generated constraint, executes an instruction of the source code generated by the symbolization unit line by line with the symbol execution engine, performs processing in accordance with the instruction reached through the instruction execution to collect path constraints, and solves the collected path constraints using a constraint solver, to generate a test case as a solution of the path constraints.

### TECHNICAL FIELD

The technology disclosed in the present specification (hereinafter referred to as the “present disclosure”) relates to an information processing device, an information processing method, and a computer program that perform a process related to software development.

### BACKGROUND ART

In software development, a behavior of software (a program, or a software program) that is different from the specification or is not assumed by the developer is called a defect, and it is desirable to correct and eliminate all defects before releasing the software. A general method for detecting a defect is a test. A test is necessary to guarantee behaviors of the program, and ensure high quality and high reliability. Generally, a test is conducted by creating inputs and outputs that are written in the specification or are expected by the developer as test cases, and checking whether the program returns correct outputs to the inputs. In a case where a correct output is not returned to an input, or where an exception (failure) occurs to hinder the program from running, it is determined that there is a defect. The developer then analyzes the program to identify the cause, and corrects the logic of the program.

However, it is said that creating a test involves a process, and about 30% of the software development process is tests. Even at present, it is common to create a test manually. For example, in some cases, the test code includes 20,000 lines, while the main body code includes 7,800 lines. Further, a large number of input values are necessary to cover all behaviors of the program. Therefore, it is difficult to manually create all the input values, and there also is a possibility that a corner case will be overlooked. Even in the above example in which the test code includes 20,000 lines while the main body code includes 7,800 lines, the coverage is only about 80%. From such a viewpoint, a technology that relates to automatic test generation for automatically generating a test code has been developed. Automatic generation of a test code can reduce the software development time and development cost, and can ensure high quality and high reliability of the software by generating exhaustive tests.

For example, IntelliTest provided by Microsoft Corporation is a tool that automatically generates a test of a C# code targeting the .NET framework, and uses symbol execution to search for an execution path of a program and automatically generate a test case. Since symbol execution involves a high execution cost, a limit is imposed on the search range so that a test can be generated in a realistic time. However, in the IntelliTest, the types of designation as listed below cannot be performed. Therefore, a test with a high coverage with respect to a code that often uses these types of designation cannot be generated.
Designate the length of a recursive data structure such as a linked list.
Determine whether or not a pointer is handled as an array.
Determine which type is to be actually passed on to a void pointer.

Also, there is a proposed test data generating device that receives selection of one or more screen transitions among screen transitions, extracts a constraint expression from a source code of a Web application on the basis of the description specification of constraints specified or defined in a framework of a Web application, and generates test data that satisfies test viewpoints of equivalence partitioning and boundary-value analyses, using the constraint expression of an input form included in the screen of the transition source of the selected screen transition (see Patent Document 1). This test data generating device generates a constraint expression by extracting what has been written into the source code by the user on the basis of the framework of a Web application. In other words, to generate useful test cases, the user must write all constraint expressions with respect to the source code. Also, this test data generating device can only select a specific input character string that satisfies a specific regular expression from among input candidates prepared in advance, and any test case cannot be generated unless there is an input that meets a constraint among the candidates. Furthermore, in this test data generating device, only the viewpoints of equivalence partitioning and boundary-value analyses are taken into consideration, and code coverage is not taken into consideration. Therefore, a coverage of 100% is not necessarily achieved, and there is a possibility that a potential bug will be overlooked.

Furthermore, there has been a proposed method for generating a test case for verifying a device by executing an existing test, acquiring a test coverage, and setting a constraint so as to be able to reach an uncovered portion (see Patent Document 2). This method targets hardware description languages such as E programming language, and an input value (test case) also includes a vector of binary values of 0 and 1. Therefore, even if this method is applied to a programming language such as a C/C++ programming language, it is not possible to solve a complicated constraint expression or cope with an ambiguous type expression (identification of a pointer to be handled as a void* or an array), and it is difficult to obtain a high coverage.

### CITATION LIST

### Patent Document

PATENT DOCUMENT 1 Japanese Patent Application Laid-Open No. 2020-67859
PATENT DOCUMENT 2 Japanese Translation of PCT International Application Publication No. 2003-535343

### SUMMARY OF THE INVENTION

### Problems to be Solved by the Invention

An object of the present disclosure is to provide an information processing device, an information processing method, and a computer program for automatically generating a test code that ensures a performance guarantee and reliability of software.

### Solutions to Problems

The present disclosure has been made in view of the above problems, and
a first aspect thereof is an information processing device that includes:
a constraint generation unit that generates a constraint from at least one of a source code, an annotation written in a source code, or an annotation of a source code written in an external file;
a symbolization unit that generates a source code that runs on a symbol execution engine and is obtained by symbolizing a motion and an input, on the basis of the constraint generated by the constraint generation unit;
an instruction execution unit that executes an instruction of the source code generated by the symbolization unit, line by line with the symbol execution engine;
a processing unit that performs processing in accordance with an instruction reached by the instruction execution unit, to collect path constraints; and
a test case generation unit that solves the collected path constraints using a constraint solver, to generate a test case as a solution of the path constraints.

In a case where the instruction execution unit has reached a conditional branch, the processing unit adds a branch condition to the path constraints, and searches for a path having a branch. Further, in a case where the instruction execution unit has reached a branch to enter a loop, the processing unit measures the line coverage of the loop. Also, the processing unit discards an execution path that is unable to meet a constraint. Furthermore, when the instruction execution unit finishes executing a function to the end, the processing unit solves the path constraints collected during a previous search using the constraint solver, to generate a test case that is a solution of the path constraints.

Further, a second aspect of the present disclosure is
an information processing method that includes:
a constraint generation step of generating a constraint from at least one of a source code, an annotation written in a source code, or an annotation of a source code written in an external file;
a symbolization unit of generating a source code that runs on a symbol execution engine and is obtained by symbolizing a motion and an input, on the basis of the constraint generated by the constraint generation step;
an instruction execution step of executing an instruction of the source code generated by the symbolization step, line by line with the symbol execution engine;
a processing step of performing processing in accordance with an instruction reached by the instruction execution step, to collect path constraints; and
a test case generation step of solving the collected path constraints using a constraint solver, to generate a test case as a solution of the path constraints.

Furthermore, a third aspect of the present disclosure is a computer program written in a computer-readable format to cause a computer to function as:
a constraint generation unit that generates a constraint from at least one of a source code, an annotation written in a source code, or an annotation of a source code written in an external file;
a symbolization unit that generates a source code that runs on a symbol execution engine and is obtained by symbolizing a motion and an input, on the basis of the constraint generated by the constraint generation unit;
an instruction execution unit that executes an instruction of the source code generated by the symbolization unit, line by line with the symbol execution engine;
a processing unit that performs processing in accordance with an instruction reached by the instruction execution unit, to collect path constraints; and
a test case generation unit that solves the collected path constraints using a constraint solver, to generate a test case as a solution of the path constraints.

The computer program according to the third aspect of the present disclosure defines a computer program written in a computer-readable format in such a manner as to achieve certain processing in the computer. In other words, by installing the computer program according to the third aspect of the present disclosure in the computer, the computer can perform a cooperative operation and produce effects similar to those produced by the information processing device according to the first aspect of the present disclosure.

### Effects of the Invention

According to the present disclosure, it is possible to provide an information processing device, an information processing method, and a computer program for automatically generating a test code that ensures a performance guarantee and reliability of software.

Note that the effects described herein are merely examples, and the effects to be produced by the present disclosure are not limited to them. Furthermore, there are cases where the present disclosure also produce additional effects in addition to the effects described above.

Other objects, features, and advantages of the present disclosure will become apparent from more detailed description based on the embodiments that will be described later and the accompanying drawings.

### BRIEF DESCRIPTION OF DRAWINGS

FIG. 1 is a diagram illustrating an example functional configuration of an automatic test generating device 100 to which the present disclosure is applied.

FIG. 2 is a chart illustrating an example (a first embodiment) of a source code for which the automatic test generating device 100 automatically generates a test code.

FIG. 3 is a chart illustrating an example (the first embodiment) of a source code obtained by symbolizing a motion and an input on a symbol execution engine.

FIG. 4 is a chart illustrating an example (the first embodiment) of a conditional branch that is first reached after a start of symbol execution.

FIG. 5 is a chart illustrating a portion (the first embodiment) of a loop included in the source code illustrated in FIG. 2.

FIG. 6 is a chart illustrating an example (the first embodiment) of a source code created in a case where a variable is changed so as to increase the number of times the loop is to be repeated.

FIG. 7 is a chart illustrating an example (the first embodiment) of a test code generated on the basis of a generated test case.

FIG. 8 is a chart illustrating an example (the first embodiment) of a log to be output as information about a loop that causes a decrease in coverage.

FIG. 9 is a chart illustrating an example (the first embodiment) of a source code after the annotation is corrected.

FIG. 10 is a chart illustrating an example (the first embodiment) of a command to be executed to start an automatic test code generation tool.

FIG. 11 is a chart illustrating another example (a second embodiment) of a source code for which the automatic test generating device 100 automatically generates a test code.

FIG. 12 is a chart illustrating an example (the second embodiment) of a source code obtained by symbolizing a motion and an input on a symbol execution engine.

FIG. 13 is a chart illustrating another example (the second embodiment) of a source code obtained by symbolizing a motion and an input on a symbol execution engine.

FIG. 14 is a chart illustrating an example (the second embodiment) of a generated test code.

FIG. 15 is a chart illustrating an example (a third embodiment) of an annotation in the format of a comment added to a source code as a test target.

FIG. 16 is a chart illustrating another example (the third embodiment) of an annotation in the format of a comment added to a source code as a test target.

FIG. 17 is a chart illustrating another example (the third embodiment) of an annotation in the format of a comment added to a source code as a test target.

FIG. 18 is a chart illustrating an example (a fourth embodiment) of an annotation added to a test target source code in a yaml format as a file different from the source code.

FIG. 19 is a diagram illustrating an example configuration of an information processing device 2000.

### MODE FOR CARRYING OUT THE INVENTION

In the description below, the present disclosure will be explained in the following order, with reference to the drawings.
A. Outline
B. Basic configuration of an automatic test generating device
C. Embodiments
C-1. First embodiment
C-2. Second embodiment
C-3. Third embodiment
C-4. Fourth embodiment
D. Configuration of an information processing device
E. Summary

### A. Outline

In developing high-quality and high-reliability programs, automatic generation of a test code is necessary to reduce time and cost, and generate exhaustive tests. Symbol execution is a technique of simulating execution of a program while updating a constraint condition, using a pair of a symbol (a symbol value) and a constraint condition for the symbol, instead of executing a program while substituting the symbol for a specific variable value written in a source code during testing of the program. By this technique, programs are exhaustively searched so that an input value that causes various behaviors is generated. Symbol execution is basically performed through the following procedures.

Step 1: Handle an input as a symbol value.

Step 2: Search each execution path of the program.

Step 3: Collect constraints for the respective execution paths.

Step 4: Solve the constraints, using a solver.

However, existing automatic test generation using symbol execution has problems as follows.

Problem 1: In a case where the argument affects the number of times a for loop is to be repeated, it takes time to generate an input value, because the search is performed by dividing cases depending on the number of times the loop is to be repeated.

Problem 2: Numerous meaningless tests are generated.

Note that, as another problem of the existing automatic test generation, there are cases where it is not possible to cope with ambiguous expressions of programming languages. Examples of ambiguous expressions of programming languages includes the following.

Example 1: a void* in C/C++, a variable-length argument, an array to be handled as a pointer, an argument to be handled as an output of a function

Example 2: dynamically typed languages, such as Python and JavaScript.

Therefore, the present disclosure proposes a technology for generating only a useful test with a high coverage by receiving an annotation from a user. The present disclosure also proposes a technique for returning a cause to a user in a case where a coverage of 100% cannot be achieved.

Note that, prior to a specific description of the present disclosure, the respective terms “static analysis”, “coverage”, “test case”, and “test code” to be used in the present specification are mentioned in advance.

The term “static analysis” as used in the present specification is not limited to a specific analysis, but refers to a type that can gather information about the argument of a test target function.

In the present specification, the term “coverage” basically refers to a line coverage. A line coverage is a percentage of lines that have been successfully executed by a test among all the lines in the source code.

A “test case” is an input to be given to a test target program. Further, a “test code” is a source code for giving various test cases to a program and executing the test cases.

### B. Basic Configuration of an Automatic Test Generating Device

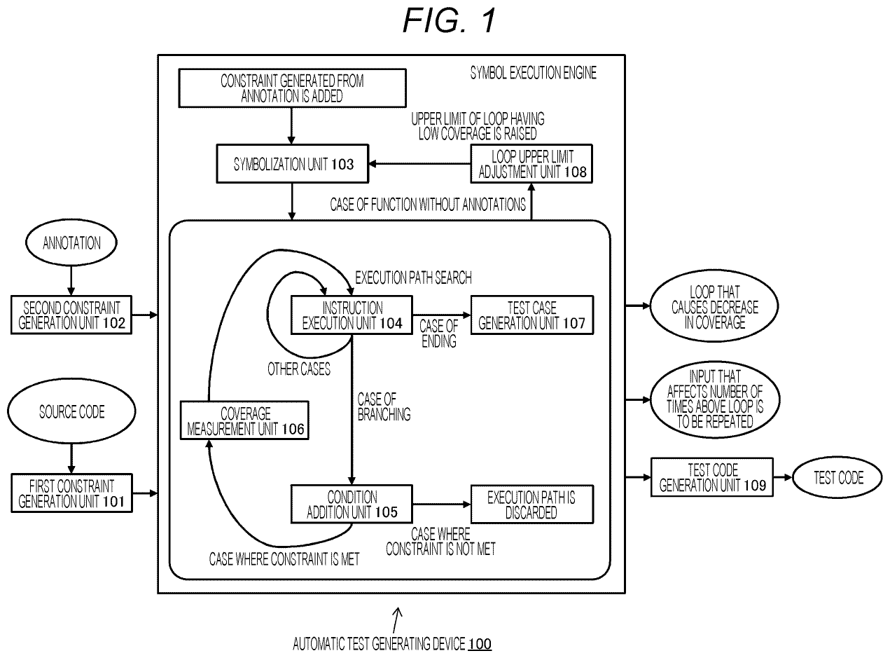

In this section B, the basic configuration of an automatic test generating device according to the present disclosure is described. FIG. 1 illustrates an example functional configuration of an automatic test generating device 100 to which the present disclosure is applied. The automatic test generating device 100 can be constructed with an information processing device such as a personal computer (PC), for example. The automatic test generating device 100 is realized by starting an automatic test code generation tool on a computer.

The automatic test generating device 100 illustrated in FIG. 1 includes a first constraint generation unit 101, a second constraint generation unit 102, and a symbol execution engine that executes symbols using the generated constraints. The symbol execution engine includes a symbolization unit 103, an instruction execution unit 104, a condition addition unit 105, a coverage measurement unit 106, a test case generation unit 107, a loop upper limit adjustment unit 108, and a test code generation unit 109.

The first constraint generation unit 101 statically analyzes an input source code, to generate as many constraints as possible.

The second constraint generation unit 102 generates constraints from an annotation written in the source code or an annotation written in an external file.

The symbolization unit 103 symbolizes an input when generating the source code running on the symbol execution engine, taking into consideration and adding the constraints generated by the first constraint generation unit 101 and the constraints generated from the annotation by the second constraint generation unit 102.

The instruction execution unit 104 executes source code instructions line by line on the symbol execution engine. The processing to be performed by the instruction execution unit 104 differs depending on the reached instruction. In a case where a conditional branch (if/for/while) is reached, the process moves on to processing by the condition addition unit 105. When execution is completed until the end of the function, the process moves on to processing by the test case generation unit 107. In the case of any other instruction, the processing by the instruction execution unit 104 is repeated.

When the instruction execution unit 104 reaches a conditional branch (if/for/while), the condition addition unit 105 adds a branch condition to a path constraint.

In a case where the coverage measurement unit 106 is to enter a loop, the coverage measurement unit 106 measures the coverage of the loop. The coverage measurement unit 106 measures the coverage by recording which instructions have been successfully executed, and which instructions have not been successfully executed for each loop that appears in the function during symbol execution.

When the instruction execution unit 104 ends a path search, the test case generation unit 107 generates a test case that is a solution of a path constraint by solving the path constraints collected during the previous search using a constraint solver.

In a case where there is a loop with a low coverage, the loop upper limit adjustment unit 108 modifies the source code running on the symbol execution engine so as to raise the upper limit of the loop, and again performs symbol execution.

The symbol execution engine processes the test cases generated by the test case generation unit 107. Furthermore, in a case where there is a loop whose coverage does not reach 100%, the symbol execution engine outputs the location of the corresponding loop on the source code and an input (a function argument) that gives the number of times the loop is to be executed, so that the annotation can be passed by the user (the developer of the program or the like). At last, the test code generation unit 109 generates a test code, on the basis of the test case processed by the symbol execution engine.

### C. Embodiments

### C-1. First Embodiment

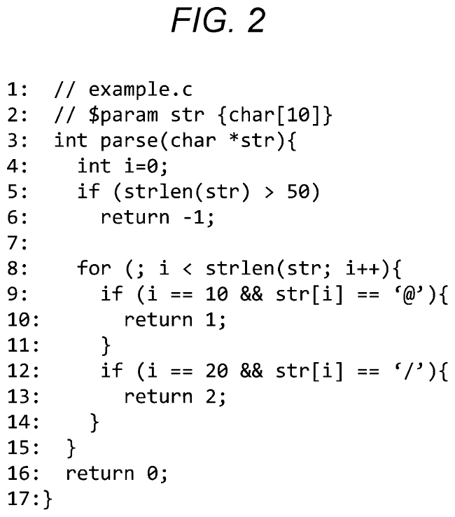

In this section C-1, an embodiment in which the automatic test generating device 100 illustrated in FIG. 1 automatically generates a test code for the source code illustrated in FIG. 2 is described.

### Step 1. Constraint Generation Based on Static Analysis:

First, the first constraint generation unit 101 statically analyzes an input source code, to generate as many constraints as possible. In the program illustrated in FIG. 2, conditional branches related to str, which is a function argument, appear in lines 5, 9, and 12. Even in a case where there are no annotations from the user, it can be seen from the conditions in these lines that str as a character string can pass all the conditions, as long as its maximum length is 51 characters. Therefore, the first constraint generation unit 101 can generate the following two constraints.
str is a char-type array with the length of 52
The 51st element (counted from 0) in str is a null (termination) character

Here, the null character is a character indicating the end of the character string, and is also referred to as the termination character. In a case where the length of the character string is counted, the null character is excluded from the count. Accordingly, the maximum length of the character string is expressed as (the length of the array)−1.

Originally, in the symbolization unit 103, the above two constraints generated by the first constraint generation unit 101 are combined with the constraint generated by the second constraint generation unit 102, to generate a source code that runs on the symbol execution engine, but explanation thereof is not made herein for convenience sake.

### Step 2. Constraint Generation Based on Annotations:

Successively, the second constraint generation unit 102 generates constraints from an annotation written in the source code or an annotation written in an external file of the source code. In the program illustrated in FIG. 2, the second constraint generation unit 102 generates a constraint, on the basis of an annotation described as a comment in the second line in “example.c”. From this annotation, the second constraint generation unit 102 can generate the following two constraints.
str is a char-type array with a length of 10
The ninth element (counted from 0) in str is a null (termination) character
   Step 3. Generation of a Source Code that Runs on the Symbol Execution Engine, and Symbolization of Inputs:

The symbolization unit 103 generates a source code that runs on the symbol execution engine, taking into account and adding the constraints generated from the annotation by the second constraint generation unit 102. The symbolization unit 103 also symbolizes the input in the source code to be generated.

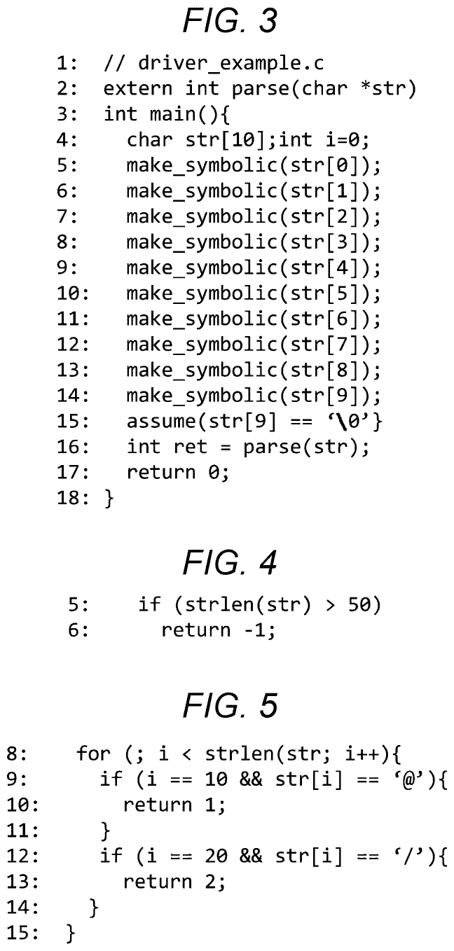

Specifically, the symbolization unit 103 generates a source code “driver_example.c” as illustrated in FIG. 3 for the test target source code illustrated in FIG. 2, on the basis of the constraints generated by the second constraint generation unit 102. The symbolization unit 103 symbolizes each element of a character string “char str[10]” to be passed on to “parse” in the source code illustrated in FIG. 3. Furthermore, the symbolization unit 103 expresses the constraint that the ninth element (counted from 0) in str is a null character in the form of “assume (str[9]==‘¥0’) (here, “¥” is a “backslash” on the source code).

### Step 4. Execution of Instructions:

Subsequently, the instruction execution unit 104 executes the instructions in the source code generated at the symbolization unit 103 line by line. Thereafter, symbol execution is performed. Specifically, instructions are executed line by line with the symbol execution engine, from the main function of the source code “driver_example.c” illustrated in FIG. 3. One of the following three processes is then performed in accordance with the instruction that has reached.
In a case where a conditional branch (if/for/while) is reached, the process moves on to processing by the condition addition unit 105.
In a case where the execution of the function is completed to the end (the 17th line in the case of the source code “driver_example.c” illustrated in FIG. 3), the process moves on to processing by the test case generation unit 107.
In any case other than the above, processing by the instruction execution unit 104 is repeated.

### Step 5. Addition of a Branch Condition to a Path Constraint:

When the instruction execution unit 104 reaches a conditional branch (if/for/while), the condition addition unit 105 adds a branch condition to a path constraint. When symbol execution is started from the main function of “driver_example.c”, a branch is reached for the first time in the fifth line in “example.c”, as illustrated in FIG. 4. Since str has a specific value assigned thereto in normal execution (not symbol execution), only one branch is performed. On the other hand, in symbol execution, both paths from a branch are searched. Therefore, the condition addition unit 105 duplicates the state of the program at the branch in the fifth line, to obtain the following states 1 and 2.

State 1: a state in a case where the condition of the if statement is satisfied

State 2: a state in a case where the condition of the if statement is not satisfied

For each of state 1 and state 2, subsequent instructions are processed separately from each other. To state 1, a condition (strlen (str)>50) in the fifth line in “example.c” is added as a path constraint. On the other hand, to state 2, negation of the condition (strlen (str)<=50) in the fifth line in “example.c” is added as a path constraint.

### Step 6. Measurement of Line Coverage of a Loop:

Further, when the instruction execution unit 104 reaches a branch entering a loop (a for/while statement or the like), the coverage measurement unit 106 records which instructions have been successfully executed, and which instructions have not been successfully executed, and measures the coverage.

Also, in a case where a path constraint that cannot be satisfied at this point of time is generated, no further path search is performed. This corresponds to “execution path is discarded” in FIG. 1.

In FIG. 5, the portion of the loop included in the source code “example.c” illustrated in FIG. 2 is extracted and shown. Referring now to FIG. 5, a process to be performed by the coverage measurement unit 106 is described. The coverage measurement unit 106 measures the coverage by recording which instructions have been successfully executed, and which instructions have not been successfully executed for each loop that appears in the function during symbol execution. When it first reaches the loop in the eighth line in “example.c”, all the instructions (which are the six lines from the ninth line to the 14th line) in the loop have not been reached, and accordingly, the coverage of the loop is 0/6=0%. In the first execution of the loop, neither the condition of the if statement in the ninth line nor that in the twelfth line can be satisfied. Therefore, at the point of time when the first search of the loop is completed, the ninth, eleventh, twelfth, and fourteenth lines have been reached, but the tenth and thirteenth lines have not yet been reached. Accordingly, the coverage in this loop is 4/6=66.67%.

Step 7. Generation of a Test Case that Satisfies Constraints:

After that, when the instruction execution unit 104 continues to execute the instructions line by line and reaches the return statement in the seventeenth line in “driver_example.c”, the path search is terminated. The test case generation unit 107 can generate a test case that is a solution of a path constraint by solving the path constraints collected during the foregoing searches using a constraint solver.

For example, a path constraint condition for arriving at the sixteenth line in “driver_example.c” after arriving at the return statement in the seventeenth line in “example.c” is as follows.
(negation of the conditional expression in the fifth line) ∧(negation of the conditional expression in the ninth line)∧(negation of the conditional expression in the eleventh line)∧(constraint added in “driver_example.c”)

This constraint condition is expressed by a mathematical expression as follows.

$$strlen ( str ) <= 50 \&\& ( i != 10 ‖ str [ i ] = ' @ ' ) \&\& ( i != 20 ‖ str [ i ] != ' / ' ) \&\& str [ 9 ] == ' ¥0 ' \qquad [ Math . 1 ]$$

By solving this conditional expression, it is possible to generate a character string as shown below, for example.

$$str [ 0 ] = ' a ' \qquad [ Math . 2 ]$$

$$str [ 1 ] = ' a '$$

$$…$$

$$str [ 8 ] = ' a '$$

$$str [ 9 ] = ' ¥0 '$$

### Step 8. Processing of a Loop Causing a Decrease in Coverage:

In a case where there is a loop with a low coverage, the loop upper limit adjustment unit 108 modifies the source code running on the symbol execution engine so as to raise the upper limit of the loop, and again performs symbol execution.

The portion of the loop included in the source code “example.c” illustrated in FIG. 5 is again referred to and studied. In a case where the length of the array str is 10, it is not possible to create a test case that satisfies the if statement in the loop in the eighth line in “example.c”. This is because the if statement in the ninth line refers to the tenth element (counted from 0) in str, the if statement in the twelfth line refers to the twentieth element (counted from 0) in str, and the length of str passed on to the parse function is insufficient. Therefore, the instruction execution unit 104 is not able to search the tenth line and the thirteenth line. This is because the instruction execution unit 104 does not search a path having a path constraint that cannot be met (as described above). Therefore, in a case where the length of the array str is 10, the coverage of this loop is 4/6=66.67%, no matter how many times a search is performed through symbol execution.

It can be considered that an unreachable portion in a loop appears due to the number of times the loop is repeated. Therefore, to increase the coverage, the loop upper limit adjustment unit 108 changes the variable to be passed on to “parse” so that the number of times the loop is to be repeated increases.

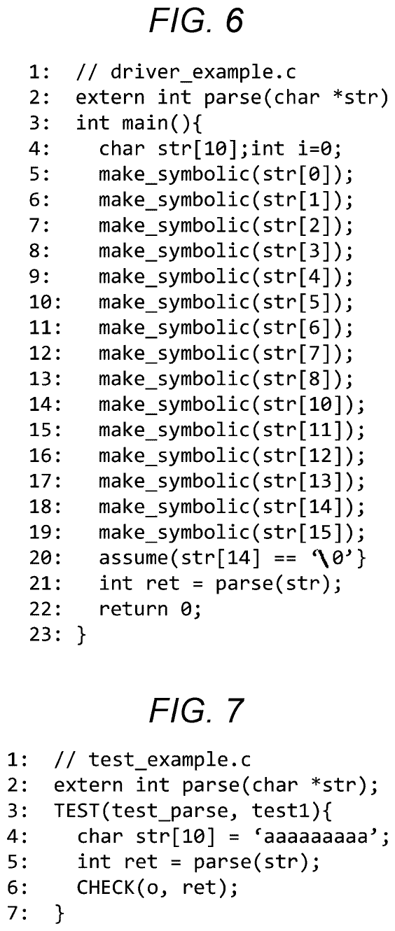

In the example of the source code illustrated in FIG. 2, the length of the array str is increased from 10 to 15, for example, and each element of the array is symbolized in a manner similar to that for “driver_example.c” before the change. As there is a constraint that the end of the array is a null character, new “driver_example.c” illustrated in FIG. 6 can be created.

The symbol execution is performed again, using the newly created “driver_example.c” (specifically, the input is symbolized by the symbolization unit 103, and is then run on the symbol execution engine). The tenth line in the loop can be reached this time, and thus, the coverage increases to 5/6=83.33%. The description below is based on the assumption that symbol execution has been executed only once in the current operation.

### Step 9. Output of a Test Code:

A test code as illustrated in FIG. 7 is generated from the test case generated in Step 7 described above.

Further, in a case where there is a loop in which the coverage does not reach 100%, the following two are also output as information about the loop that causes a decrease in coverage.
The location of the corresponding loop on the source code
The input (function argument) that affects the number of times the loop is to be executed

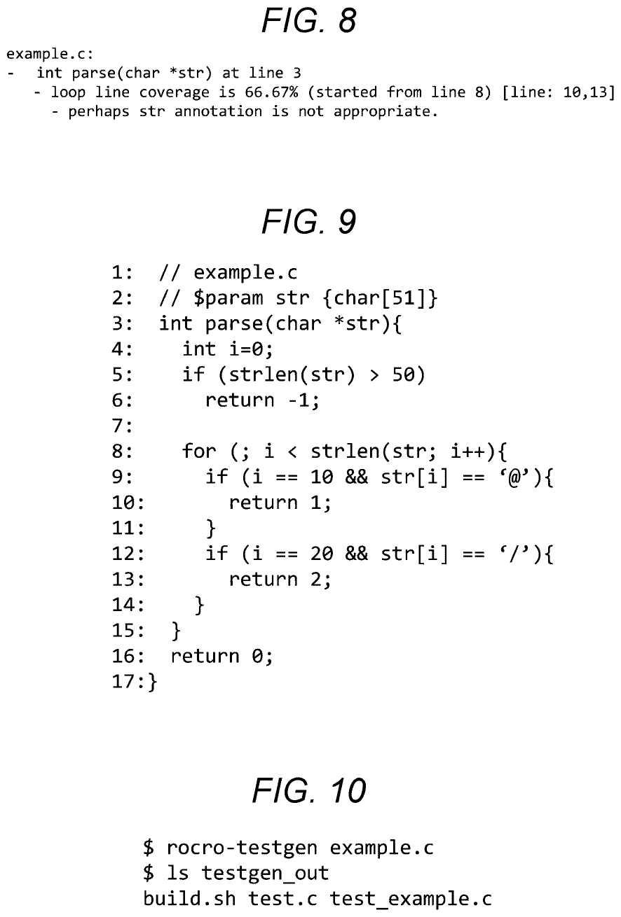

FIG. 8 illustrates an example of a log that is output as information about the loop that causes a decrease in coverage.

The user (the developer of the program) can find that the annotation added to the argument str of the parse function is inappropriate, on the basis of the information as illustrated in FIG. 8. The user understands that this is because the parse function is designed to return an error (to return −1) in a case where str is a character string longer than 50 characters. As the length of the array str is set to 51 (a maximum of 50 characters as a character string), it is possible to create a test case that does not cause an error in the automatic test generating device 100 by giving an annotation to the original source code (or correcting the annotation). Specifically, the annotation “$param str {char}” in the second line in the original source code illustrated in FIG. 2 is corrected to “$param str {char}”, so that the source code “example.c” illustrated in FIG. 9 is obtained.

On the other hand, in a case where a test in which the coverage of the parse function reaches 100% is to be generated, generation of a test including a test case that returns an error is enabled, and this can be done by adding the following annotation.

$$\$ param str \{ char [ 52 ] \} , \qquad [ Math . 3 ]$$

$$instead of \$ param str \{ char [ 51 ] \}$$

However, the above is merely an example, and how to specifically correct the annotation needs to be determined in view of what kind of test is required, with the preconditions and implementation of the function being taken into consideration.

By executing the command illustrated in FIG. 10 on a command line, it is possible to start an automatic test code generation tool (rocro-testgen). With the automatic test code generation tool, a unit test for each function of the source code “example.c” can be automatically generated. The automatically generated test code (test_example.c) and the source code (test.c) having the main function for calling the test code are disposed under a specific directory (testgen_out in the present embodiment). A script (build.sh) for building the test is also generated.

Note that “to build” means to perform compilation and linking to generate an executable file. Further, a “script” is a source code written in a language in which execution is possible without compilation. Furthermore, a “unit test” is a test of a functional unit of a program. By calling each function and giving various input values before execution, a check is made to determine whether the function is correctly implemented. Conversely, a test for executing the entire program is referred to as a “system test”.

### C-2. Second Embodiment

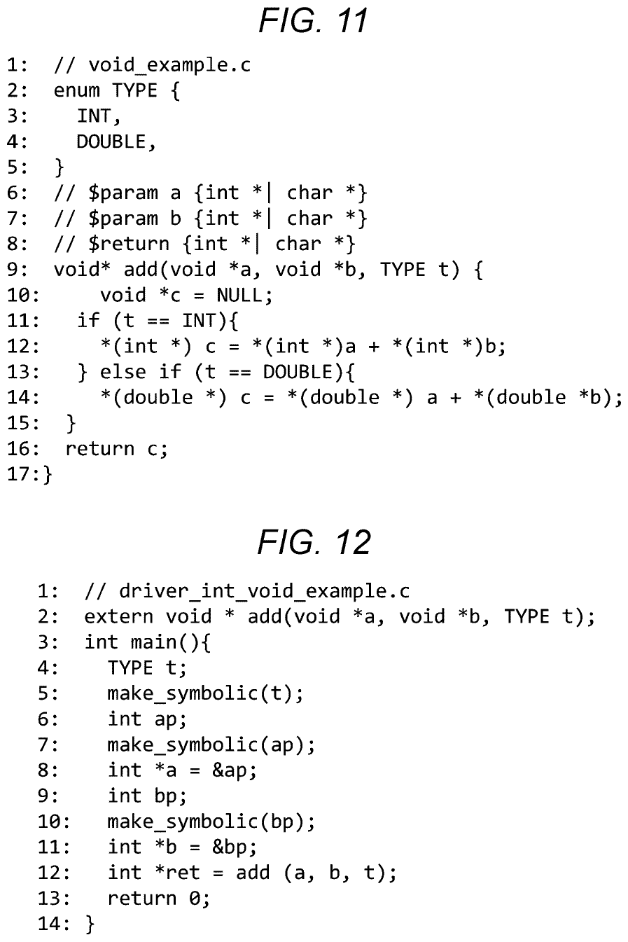

In this section C-2, an embodiment in which the automatic test generating device 100 illustrated in FIG. 1 automatically generates a test code for the source code illustrated in FIG. 11 is described (an example of a void pointer). Also, in the second embodiment, the automatic test generating device 100 generates a test code, following the procedures of Steps 1 to 9, as in the case of the first embodiment described above. In this section C-2, differences from the first embodiment or features as the second embodiment are mainly described.

A void pointer of C/C++ may originally include a pointer to any type. Therefore, to generate a test for a void pointer, it is necessary to output a huge number of test cases, with all types being taken into consideration.

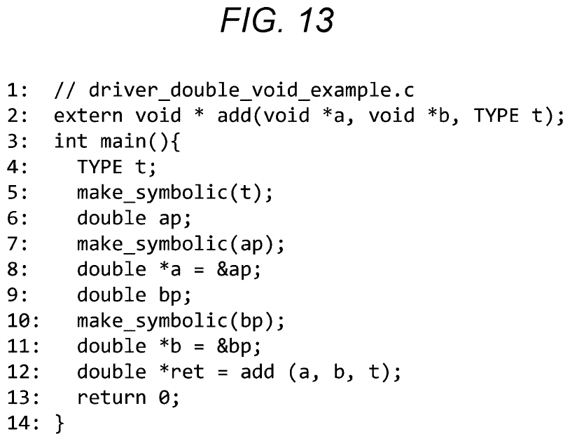

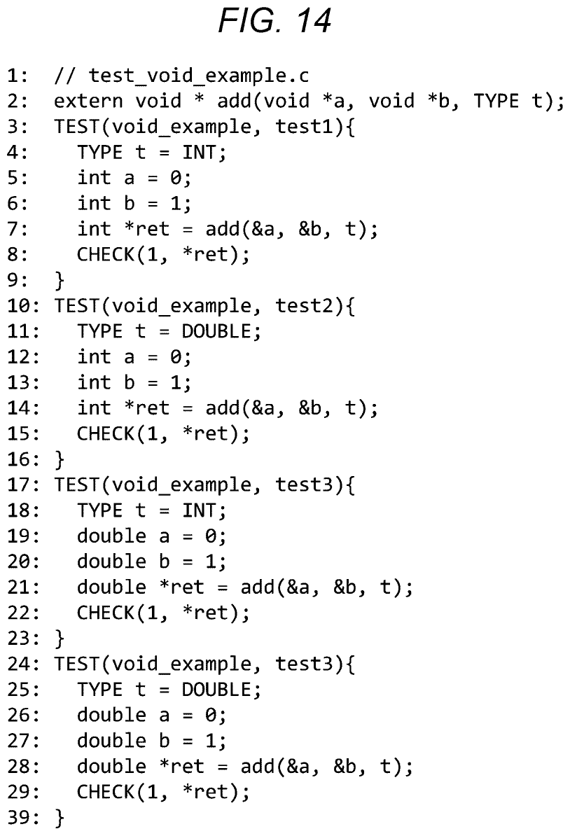

By giving an annotation about the types that can be substituted into the void pointer as in the sixth to eighth lines in a source code “void_example.c” shown in FIG. 11, a test case can be generated using only a designated type. In Step 3, the automatic test generating device 100 generates source codes “driver_int_void_example.c” and “driver_double_void_example.c” that run on the symbol execution engine, as illustrated in FIGS. 12 and 13. Further, in Step 9, the automatic test generating device 100 generates a test code “test_void_example.c” as illustrated in FIG. 14.

### C-3. Third Embodiment

In this section C-3, an embodiment in which the automatic test generating device 100 illustrated in FIG. 1 processes a source code having an annotation added thereto and generates a constraint is described.

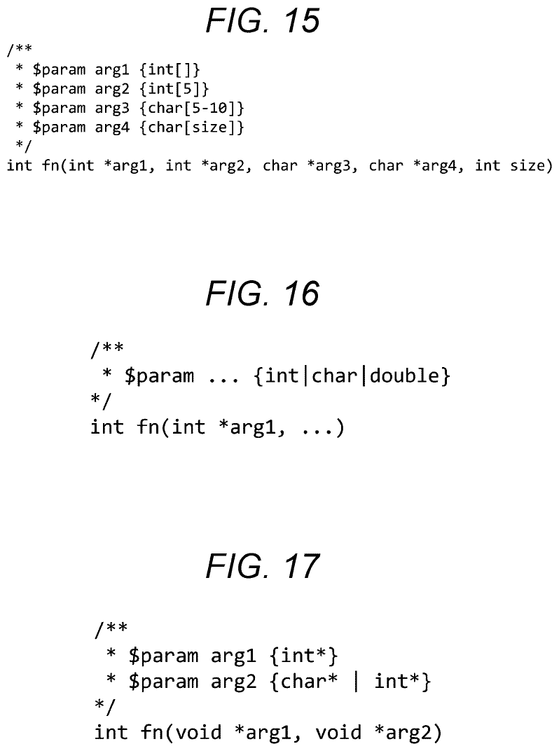

The automatic test generating device 100 can process an annotation added in the form of a comment to generate a constraint, with respect to the test target function. For example, the automatic test generating device 100 can process an annotation as shown below, which has been added with respect to designation of a pointer to be handled as an array. FIG. 15 illustrates a specific example of the annotation in the form of a comment, which has been added with respect to designation of the pointer to be handled as an array for the source code of the test target.
arg1 designates only an int-type array, but does not designate its length. In this case, it is handled as an array having a length (5, for example) determined by default.
arg2 is handled as an int-type array having a length of 5.
arg3 is of a char type, and is handled as an array having a lower limit of length of 5 and an upper limit of 10.
arg4 is of a char type, and is handled as an array having a length “size”.

Also, the automatic test generating device 100 can process an annotation as shown below, which has been added with respect to designation of the argument type to be passed on to a variable-length argument. FIG. 16 illustrates a specific example of the annotation in the form of a comment, which has been added with respect to designation of the argument type to be passed on to the variable-length argument for the source code of the test target.
An “int”, “char”, or “double” type is passed on to the variable-length argument.
Because the test case will be huge when all the combinations are taken into consideration, the type to be passed on to the variable-length argument is fixed to one of the designated types. That is, test cases such that fn(int, int, int), fn(int, char, char), fn(int, double, double), . . . are generated.

Further, the automatic test generating device 100 can process an annotation as shown below, which has been added with respect to designation of the pointer type to be actually passed on to a void pointer. FIG. 17 illustrates a specific example of the annotation in the form of a comment, which has been added with respect to designation of the argument type to be passed on to the variable-length argument for the source code of the test target.
arg1 is handled as a pointer to an “int” type.
arg2 is handled as a pointer to a “char” type or a pointer to an “int” type.

### C-4. Fourth Embodiment

In this C-4, which differs from the section C-3 described above, an embodiment in which the automatic test generating device 100 illustrated in FIG. 1 processes an annotation written in a file different from the source code to generate a constraint is described.

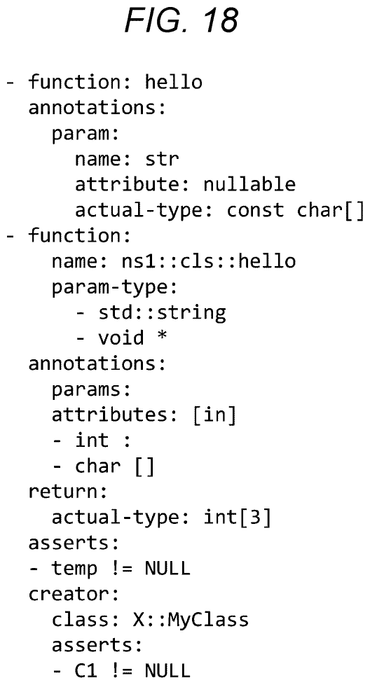

With respect to the test target function, the automatic test generating device 100 can generate a constraint by processing an annotation added in the yaml format in a file different from the file in which the test target function is written. FIG. 18 illustrates a specific example of the annotation that is written in the file in the yaml format and is added to the source code.

### D. Configuration of an Information Processing Device

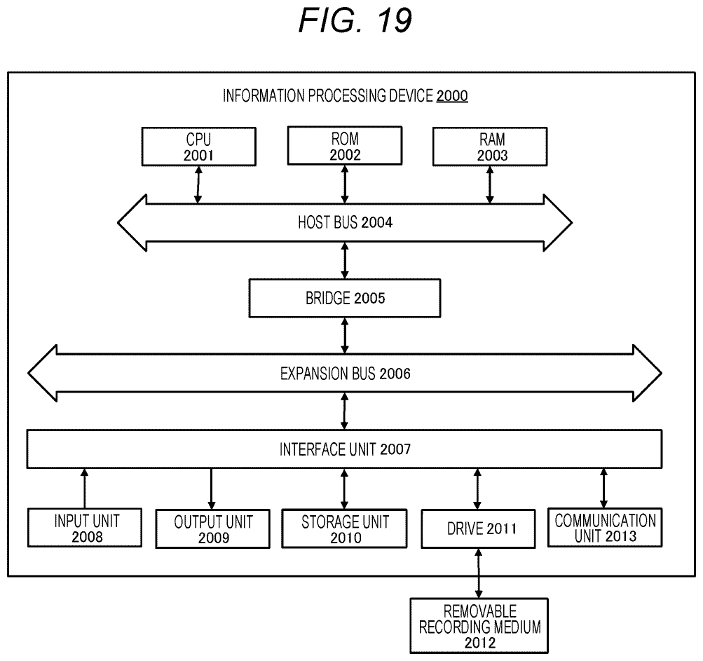

FIG. 19 illustrates an example configuration of an information processing device 2000 that can operate as the automatic test generating device 100. The information processing device 2000 is formed with a PC, for example, and is used for program development and testing of developed programs.

The information processing device 2000 illustrated in FIG. 19 includes a central processing unit (CPU) 2001, a read only memory (ROM) 2002, a random access memory (RAM) 2003, a host bus 2004, a bridge 2005, an expansion bus 2006, an interface unit 2007, an input unit 2008, an output unit 2009, a storage unit 2010, a drive 2011, and a communication unit 2013.

The CPU 2001 functions as an arithmetic processing device and a control device, and controls overall operation of the information processing device 2000 in accordance with various programs. The ROM 2002 stores programs (a basic input/output system and the like) and calculation parameters to be used by the CPU 2001, in a nonvolatile manner. The RAM 2003 is used to load a program to be used by the CPU 2001 to execute the program, and temporarily store parameters such as work data that appropriately changes during execution of a program. Examples of the program to be loaded into the RAM 2003 and executed by the CPU 2001 include various application programs, an operating system (OS), and the like. In the present embodiment, the CPU 2001 executes a program corresponding to the above-described “automatic test code generation tool”, so that the information processing device 2000 can function as the automatic test generating device 100.

The CPU 2001, the ROM 2002, and the RAM 2003 are interconnected by the host bus 2004 formed with a CPU bus or the like. The CPU 2001 then operates in conjunction with the ROM 2002 and the RAM 2003 to execute various application programs under an execution environment provided by the OS, to enable various functions and services to be implemented. In a case where the information processing device 100 is a personal computer, the OS is Windows of Microsoft Corporation or Unix, for example.

The host bus 2004 is connected to the expansion bus 2006 via the bridge 2005. The expansion bus 2006 is a peripheral component interconnect (PCI) bus or PCI Express, for example, and the bridge 2005 is based on the PCI standard. However, the information processing device 2000 does not necessarily have a configuration in which circuit components are separated by the host bus 2004, the bridge 2005, and the expansion bus 2006, but may be implemented so that almost all circuit components are interconnected by a single bus (not illustrated).

The interface unit 2007 connects peripheral devices such as the input unit 2008, the output unit 2009, the storage unit 2010, the drive 2011, and the communication unit 2013, in accordance with the standard for the expansion bus 2006. However, all of the peripheral devices illustrated in FIG. 10 are not necessarily essential, and the information processing device 2000 may further include some other peripheral device (not illustrated). Furthermore, the peripheral devices may be included in the main body of the information processing device 2000, or some of the peripheral devices may be externally connected to the main body of the information processing device 2000.

The input unit 2008 includes an input control circuit or the like that generates an input signal on the basis of an input from a user to output the input signal to the CPU 2001. In a case where the information processing device 2000 is a personal computer, the input unit 2008 may include a keyboard, a mouse, and a touch panel, and may further include a camera and a microphone. In the present embodiment, in a case where the coverage of a loop cannot be made to reach 100% during symbol execution of the source code, the user is made to pass the annotation, using the input unit 2008.

The output unit 2009 includes a display device such as a liquid crystal display (LCD) device, an organic electro-luminescence (EL) display device, or a light emitting diode (LED), for example. Also, the output unit 2009 may include an audio output device such as a speaker and headphones, and output at least part of a message to the user as displayed on the UI screen, as an audio message. In the present embodiment, in a case where the coverage of a loop cannot be made to reach 100%, during symbol execution of the source code, the output unit 2009 is used to return information about the loop requiring an annotation and the input variable, so as to make the user pass the annotation.

The storage unit 2010 stores files of programs (applications, the OS, and the like) to be executed by the CPU 2001, various pieces of data, and the like. The data stored in the storage unit 2010 may include a corpus (described above) of regular speeches and whispers for training of a neural network. Although the storage unit 2010 is formed with a large-capacity storage device such as a solid state drive (SSD) or a hard disk drive (HDD), for example, it may include an external storage device.

A removable storage medium 2012 is a cartridge-type storage medium such as a micro-SD card, for example. The drive 2011 performs read and write operations on the removable storage medium 113 loaded therein. The drive 2011 outputs data read from the removable recording medium 2012 to the RAM 2003 and the storage unit 2010, and writes data on the RAM 2003 and the storage unit 2010, into the removable recording medium 2012.

The communication unit 2013 is a device that performs wireless communication such as Wi-Fi (registered trademark), Bluetooth (registered trademark), or a cellular communication network such as 4G or 5G. The communication unit 2013 also include a terminal such as a universal serial bus (USB) or a high-definition multimedia interface (HDMI, a registered trademark), and may further include a function of performing HDMI (registered trademark) communication with a USB device such as a scanner or a printer, a display, or the like.

Although a PC is assumed to be the information processing device 2000 herein, the number of PCs is not limited to one. Two or more devices may perform program development and testing of developed programs in a distributed manner.

### E. Summary

At last, features and advantages of the present disclosure are summarized.

(1) According to the present disclosure, it is possible to automatically generate a test code with a higher coverage than that in simple symbol execution within a realistic time, using an annotation received from a user. In particular, a pointer that is handled as a type or an array to be actually passed on to a void* or a variable-length argument cannot acquire sufficient information only by analyzing a source code, but, according to the present disclosure, a high coverage can be achieved.

(2) According to the present disclosure, even in a case where there are no annotations from the user, it is possible to add as many constraints as possible for eliminating unnecessary tests, by statically analyzing an input source code. For example, the length of a variable-length array can be inferred to some extent from a branch condition in a for statement, and, according to the present disclosure, it can be used in test generation.

(3) According to the present disclosure, it is possible to measure the coverage in a loop during symbol execution so as to obtain as high a coverage as possible even without an annotation. In a case where the coverage is lower than 100%, it is possible to increase the upper limit of the number of times a loop search is performed, and generate a test case by performing symbol execution again.

(4) According to the present disclosure, in a case where the coverage of the loop cannot be made to reach 100% by any means, it is possible to return information regarding the loop that requires an annotation and the input variable so that the annotation can be passed by the user.

### INDUSTRIAL APPLICABILITY

The present disclosure has been described in detail so far, with reference to specific embodiments. However, it is obvious that those skilled in the art can make modifications and substitutions of the embodiment without departing from the scope of the present disclosure. In short, the present disclosure has been described in an illustrative manner, and the contents disclosed in the present specification should not be interpreted in a limited manner. To determine the subject matter of the present disclosure, the claims should be taken into consideration.

Note that the present disclosure may also have the following configurations.

(1) An information processing device including:
a constraint generation unit that generates a constraint from at least one of a source code, an annotation written in a source code, or an annotation of a source code written in an external file;
a symbolization unit that generates a source code that runs on a symbol execution engine and is obtained by symbolizing a motion and an input, on the basis of the constraint generated by the constraint generation unit;
an instruction execution unit that executes an instruction of the source code generated by the symbolization unit, line by line with the symbol execution engine;
a processing unit that performs processing in accordance with an instruction reached by the instruction execution unit, to collect path constraints; and
a test case generation unit that solves the collected path constraints using a constraint solver, to generate a test case as a solution of the path constraints.

(2) The information processing device according to (1), in which,
in a case where the instruction execution unit has reached a conditional branch, the processing unit adds a branch condition to the path constraints, and searches for a path having a branch.

(3) The information processing device according to (2), in which,
in a case where the instruction execution unit has reached a branch to enter a loop, the processing unit measures a line coverage of the loop.

(4) The information processing device according to (2) or (3), in which
the processing unit discards an execution path that is unable to meet a constraint.

(5) The information processing device according to any one of (2) to (4), in which,
when the instruction execution unit finishes executing a function to an end, the processing unit solves the path constraints collected during a previous search using the constraint solver, to generate a test case that is a solution of the path constraints.

(6) The information processing device according to any one of (1) to (5), further including
a loop upper limit adjustment unit that modifies the source code running on the symbol execution engine, to raise an upper limit of a loop having a low coverage, and again enable symbol execution.

(7) The information processing device according to (5), further including
a test code generation unit that generates a test code on the basis of the generated test case.

(8) The information processing device according to (7), in which
the test code generation unit outputs information about a loop that causes a decrease in coverage.

(8-1) The information processing device according to (8), in which
the information includes a location of a corresponding loop on the source code, and an input (a function argument) that affects the number of times the loop is to be executed.

(9) The information processing device according to any one of (1) to (8), further including
an annotation processing unit that processes an annotation added to a test target function.

(10) The information processing device according to (9), in which
the annotation processing unit processes an annotation added in a form of a comment regarding designation of a pointer to be handled as an array.

(11) The information processing device according to (9), in which
the annotation processing unit processes an annotation added in a form of a comment regarding designation of an argument type to be passed on to a variable-length argument.

(12) The information processing device according to (9), in which
the annotation processing unit processes an annotation added in a form of a comment regarding designation of a pointer type to be actually passed on to a void pointer.

(13) The information processing device according to (9), in which,
with respect to the test target function, the annotation processing unit processes an annotation added in a yaml format in a file different from a file in which the test target function is written.

(14) An information processing method including:
a constraint generation step of generating a constraint from at least one of a source code, an annotation written in a source code, or an annotation of a source code written in an external file;
a symbolization unit of generating a source code that runs on a symbol execution engine and is obtained by symbolizing a motion and an input, on the basis of the constraint generated by the constraint generation step;
an instruction execution step of executing an instruction of the source code generated by the symbolization step, line by line with the symbol execution engine;
a processing step of performing processing in accordance with an instruction reached by the instruction execution step, to collect path constraints; and
a test case generation step of solving the collected path constraints using a constraint solver, to generate a test case as a solution of the path constraints.

(15) A computer program written in a computer-readable format to cause a computer to function as:
a constraint generation unit that generates a constraint from at least one of a source code, an annotation written in a source code, or an annotation of a source code written in an external file;
a symbolization unit that generates a source code that runs on a symbol execution engine and is obtained by symbolizing a motion and an input, on the basis of the constraint generated by the constraint generation unit;
an instruction execution unit that executes an instruction of the source code generated by the symbolization unit, line by line with the symbol execution engine;
a processing unit that performs processing in accordance with an instruction reached by the instruction execution unit, to collect path constraints; and
a test case generation unit that solves the collected path constraints using a constraint solver, to generate a test case as a solution of the path constraints.

### REFERENCE SIGNS LIST

100 Automatic test generating device
101 First constraint generation unit
102 Second constraint generation unit
103 Symbolization unit
104 Instruction execution unit
105 Condition addition unit
106 Coverage measurement unit
107 Test case generation unit
108 Loop upper limit adjustment unit
109 Test code generation unit
2000 Information processing device
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit

1. An information processing device comprising:
a constraint generation unit that generates a constraint from at least one of a source code, an annotation written in a source code, or an annotation of a source code written in an external file;
a symbolization unit that generates a source code that runs on a symbol execution engine and is obtained by symbolizing a motion and an input, on a basis of the constraint generated by the constraint generation unit;
an instruction execution unit that executes an instruction of the source code generated by the symbolization unit, line by line with the symbol execution engine;
a processing unit that performs processing in accordance with an instruction reached by the instruction execution unit, to collect path constraints; and
a test case generation unit that solves the collected path constraints using a constraint solver, to generate a test case as a solution of the path constraints.

2. The information processing device according to claim 1, wherein,
in a case where the instruction execution unit has reached a conditional branch, the processing unit adds a branch condition to the path constraints, and searches for a path having a branch.

3. The information processing device according to claim 2, wherein,
in a case where the instruction execution unit has reached a branch to enter a loop, the processing unit measures a line coverage of the loop.

4. The information processing device according to claim 2, wherein
the processing unit discards an execution path that is unable to meet a constraint.

5. The information processing device according to claim 2, wherein,
when the instruction execution unit finishes executing a function to an end, the processing unit solves the path constraints collected during a previous search using the constraint solver, to generate a test case that is a solution of the path constraints.

6. The information processing device according to claim 1, further comprising
a loop upper limit adjustment unit that modifies the source code running on the symbol execution engine, to raise an upper limit of a loop having a low coverage, and again enable symbol execution.

7. The information processing device according to claim 5, further comprising
a test code generation unit that generates a test code on a basis of the generated test case.

8. The information processing device according to claim 7, wherein
the test code generation unit outputs information about a loop that causes a decrease in coverage.

9. The information processing device according to claim 1, further comprising
an annotation processing unit that processes an annotation added to a test target function.

10. The information processing device according to claim 9, wherein
the annotation processing unit processes an annotation added in a form of a comment regarding designation of a pointer to be handled as an array.

11. The information processing device according to claim 9, wherein
the annotation processing unit processes an annotation added in a form of a comment regarding designation of an argument type to be passed on to a variable-length argument.

12. The information processing device according to claim 9, wherein
the annotation processing unit processes an annotation added in a form of a comment regarding designation of a pointer type to be actually passed on to a void pointer.

13. The information processing device according to claim 9, wherein,
with respect to the test target function, the annotation processing unit processes an annotation added in a yaml format in a file different from a file in which the test target function is written.

14. An information processing method comprising:
a constraint generation step of generating a constraint from at least one of a source code, an annotation written in a source code, or an annotation of a source code written in an external file;
a symbolization unit of generating a source code that runs on a symbol execution engine and is obtained by symbolizing a motion and an input, on a basis of the constraint generated by the constraint generation step;
an instruction execution step of executing an instruction of the source code generated by the symbolization step, line by line with the symbol execution engine;
a processing step of performing processing in accordance with an instruction reached by the instruction execution step, to collect path constraints; and
a test case generation step of solving the collected path constraints using a constraint solver, to generate a test case as a solution of the path constraints.

15. A computer program written in a computer-readable format to cause a computer to function as:
a constraint generation unit that generates a constraint from at least one of a source code, an annotation written in a source code, or an annotation of a source code written in an external file;
a symbolization unit that generates a source code that runs on a symbol execution engine and is obtained by symbolizing a motion and an input, on a basis of the constraint generated by the constraint generation unit;
an instruction execution unit that executes an instruction of the source code generated by the symbolization unit, line by line with the symbol execution engine;
a processing unit that performs processing in accordance with an instruction reached by the instruction execution unit, to collect path constraints; and
a test case generation unit that solves the collected path constraints using a constraint solver, to generate a test case as a solution of the path constraints.
